(19) United States
(12) Patent Application Publication
(10) Pub. No.: US 2014/0356608 A1
(43) Pub. Date: Dec. 4, 2014

(54) METHOD FOR PRODUCING GLASSES, GLASS CERAMICS AND THE USE THEREOF

(71) Applicant: SCHOTT AG, Mainz (DE)

(72) Inventors: Frank-Thomas LENTES, Bingen (DE); Karin NAUMANN, Ober-Olm (DE); Ulrich SCHIFFNER, Mainz (DE); Friedrich SIEBERS, Nierstein (DE); Christian MUELLER, Mainz (DE); Klaus SCHOENBERGER, Mainz (DE); Evelin WEISS, Mainz (DE)

(21) Appl. No.: 14/463,636

(22) Filed: Aug. 19, 2014

Related U.S. Application Data
(63) Continuation of application No. PCT/EP2013/053187, filed on Feb. 18, 2013.

(30) Foreign Application Priority Data
Feb. 22, 2012 (DE) 102012202695.9

(51) Int. Cl. C03B 5/225; C03C 3/087; C03C 3/085; C03C 10/00; C03C 3/095

(52) U.S. Cl. CPC C03B 5/225; C03C 10/0009; C03C 3/095; C03C 3/085; C03C 3/087
USPC 428/220; 65/134.3; 65/66; 65/90; 501/32; 501/11; 501/64; 501/69; 501/70

(57) ABSTRACT

A method for producing bubble-free glasses is provided, in which a glass mixture that is arsenic-free and antimony-free with the exception of any unavoidable raw material impurities and a sulfate compound and SnO₂ as refining agents are used. The glass mixture is melted and primarily refined in a first region of a melting tank, an average melting temperature (T1) is set at T1>1560° C. and an average melt residence time (t1) is set at t1>2 hours. The proportion of SO₃ resulting from the decomposition of the sulfate compound is reduced to less than 0.002 wt. % as the primary refinement is carried out. A secondary refinement is carried out in a second region of the melting tank, an average melting temperature (T2) is set at T2>1640° C. and an average melt residence time (t2) is set at t2>1 hour.

### CROSS REFERENCE TO RELATED APPLICATIONS

This application is a continuation of International Application Serial No. PCT/EP2013/053187 filed Feb. 18, 2013, which claims benefit under 35 U.S.C. §119(a) of German Patent Application No. 10 2012 202 695.9, filed Feb. 22, 2012, the entire contents of both of which are incorporated herein by reference.

### BACKGROUND

1. Field of the Disclosure

The invention relates to a method for producing glasses, in particular LAS glasses and alkali-free aluminosilicate glasses, as well as glasses for the production of glass ceramics. The invention also relates to glasses and glass ceramics, and the use thereof.

2. Description of Related Art

For the production of glass, a mixture or batch is introduced into a furnace melting tank and the batch is melted, the mixture first being converted to the stage of the batch agglomeration phase, which is also designated the raw melting, which describes the melting process of the batch.

A batch cover forms thereby, underneath which the melt moves in the form of a counterclockwise principal flow vortex. A hot melt flow partially detaches from this flow vortex and rises toward the top. This point is called the thermal source point. The source point in a furnace melting tank marks the transfer from the first region into the second region of the furnace tank.

In “Glastechnische Fabrikationsfehler—Technical Glass Manufacturing Defects”, edited by H. Jepsen-Marwedel and R. Brückner, 4th Edition, Springer Publ. Co., it is described that under the influence of high temperatures in the furnace melting tank, a thin melt layer, the thickness of which amounts to only several millimeters and which flows off under the effect of gravity, is formed on the surface of the batch. Due to gases erupting from the inside the batch, which form large bubbles and can cause the melt layer to appear full of holes, the newly formed glass melt is pushed away from the batch.

The batch is essentially heated and melted by the flow of glass penetrating below the batch carpet. The reaction gas formed at the hot melt front on the underside of the batch penetrates into the porous batch layer and flows to the top through the hollow spaces.

The increase in temperature inside the batch layer proceeds slowly, so that sufficient time remains for the course of the melt reactions. The reactions in the batch agglomeration phase are different for individual glass systems. In general, however, at first, due to solid-solid reactions, the more reactive components form solid solutions and eutectic phases, which then also accelerate other reactions between the less-reactive batch components due to the formation of the melt.

During the raw melting, up to approximately 1400° C., silicate-forming reactions are concluded and subsequently, the remaining quartz grains, Al₂O₃ grains, and zirconium-containing grains are dissolved. For the rate of dissolution, in addition to temperature, the quantity of undissolved grains and their size represent determining factors.

Up to 20 wt. % gases, which are bound to the raw materials, are introduced into the furnace melting tank with the batch. Due to the decomposition of these raw materials, particularly the carbonates, huge amounts of gases are released, the principal amount of which is discharged into the furnace atmosphere during the batch agglomeration phase and the raw melting. The remainder of approximately 0.001 to 0.1 vol. % of the evolved quantity of gas still remaining in the form of bubbles after the raw melting, as well as the gases remaining dissolved in the melt, must be removed or must be reduced to an extent that is no longer disruptive during the subsequent refining process.

Primarily during the process of dissolving sand grains and zirconium-containing grains, small gas bubbles arise on them that must also be removed from the glass melt.

Shards, preferably shards specific to the glass type, may also be added to the batch in a concentration of up to more than 50%.

The object of the refining is to remove bubbles that are still present, to reduce the concentration of dissolved gases, which could give rise to post-gases, and to homogenize the melt. For this purpose, thermal, mechanical, and chemical refining methods or a combination thereof are used in glass technology.

All technical-process measures for refining have the objective of decreasing the rise velocity v of bubbles and thus the time for the bubbles to rise. The rise velocity v of bubbles with a diameter d is given according to Stokes by:

$$v = \frac{1}{18} \frac{g ρ {d}^{2}}{η} .$$

(g: acceleration due to gravity; ρ: density of the glass melt, η: viscosity of the glass melt)

In order to increase the bubble rise velocity, two parameters can be changed essentially: the diameter of the bubbles d can be increased (very effective due to d²) and/or the viscosity of the glass melt can be reduced by increasing the temperature in the refining region.

It is described in DE 199 39 771 A1 that in general two principal refining methods are known, which differ essentially by the type and manner of producing the refining gas.

In the physical refining method, the viscosity of the glass melt is reduced by increasing the temperature. Therefore, in order to reduce the viscosity during the refining, higher temperatures are established in the glass melt than in the melting and standing regions. The higher the refining temperature can be selected in each case, the more effective is the removal of bubbles from the melt. In this case, the viscosity of the melt should be <10² dPa·s as much as possible. The maximum permissible refining temperature, however, is limited by the temperature resistance of the wall material of the melting aggregate used each time, and is approximately 1720° C. in conventional furnace melting tanks.

Most frequently chemical refining methods are used. The principle here is that compounds are added to the batch that can either decompose and give rise to gases or which are volatile at higher temperatures, or which deliver gases in an equilibrium reaction at higher temperatures. These respective gases diffuse into the bubbles that are present and enlarge them. For example, sodium sulfate that is used, e.g., for the refining of soda-lime glasses belongs to the first group of compounds. In this case, SO₂ and O₂ are delivered in a temperature range of 1100° C. to 1450° C. with a maximum at 1380° C. This temperature range approximately corresponds to the refining range of such glasses.

By way of another example, sodium chlorides belong to the second group of compounds, and polyvalent oxides such as As₂O₃ or SnO₂ belong to the last group of compounds.

Glasses for the production of transparent, colored glass ceramics, for the production of which SnO₂ or sulfate compounds, among others, are used as refining agents, are known from DE 199 39 787 A1. These refining agents are utilized as replacements for the refining agents, arsenic oxide or antimony oxide. The high-temperature refining occurs at temperatures of more than 1975° C. Information on the number of bubbles obtained, however, is not given for glasses containing these types of refining agents.

It has been shown that with the use of sulfates during high-temperature refining above 1750° C., spontaneous new bubble formation occurs (so-called reboil bubbles) due to the greatly increasing partial pressures of O₂ and particularly of SO₂ to >5 bars. The low bubble concentration achieved in the upstream refining stages increases again thereby, so that a bubble concentration of >2/kg results in the product.

In U.S. Pat. No. 7,763,559 B2, SnO₂ is used as the refining agent, but sulfate is expressly excluded due to the reboil effect.

U.S. Pat. No. 6,376,403 B1 discloses SnO₂ and sulfates as refining agents, the proportions of which are indicated as 0.1 to 3 mol. % SnO₂ and 0.004 to 0.1 mol. % S. The subject of this document is a material composition for hard-disk substrates; a description of the method for achieving a pre-specified bubble concentration is absent.

DE 10346197 B4 describes SnO₂ as a refining agent that is added in an amount of up to 4 wt. %. The glass composition can also contain in total 0 to 4 wt. % of SO₄⁻ and Cl⁻. A description of the method in the form of temperature-time curves for achieving a bubble concentration that is as small as possible is absent.

A method in which the raw material of the melt is melted at a temperature T₁ and then the melt is cooled to a second temperature T₂ is known from WO 2007/018910 A2 and WO 2008/123942 A1. Subsequently, an oxidizing gas is introduced and the cooled melt is brought to a temperature T₃>T₁. Only SnO₂ is mentioned as the refining agent. The cooling of the melt with an introduction of the oxidizing gas is necessary in order to oxidize again to SnO₂ the largest possible proportion of the SnO arising unintentionally during the melting phase. For this purpose, the partial pressure of the O₂ in the melt must be reduced to clearly less than 1 bar for the oxidizing gas that is passed through by means of decreasing the temperature.

It is known from WO 2008/065166 that interactions that reduce the transmission and shift the color in the direction of yellow or yellow-brown occur with the use of TiO₂ as the nucleating agent with the simultaneous presence of Fe₂O₃, CeO₂, or SnO₂. This effect is particularly strongly pronounced in the presence of SnO₂. A content of approximately 0.2 wt. % SnO₂ with transparent, uncolored LAS glass ceramics leads to noticeable adverse effects on transmission and color (yellow coloring).

A method for the environmentally-friendly melting and refining of a glass melt for an initial glass of an LAS glass ceramic is known from DE 10 2009 011 850 B3, in which, by renouncing arsenic and antimony as refining agents, an addition of 0.1 to <0.6 wt. % of tin oxide is used as the principal refining agent.

### SUMMARY

The object of the invention consists of indicating a method for producing bubble-free glasses, in particular LAS glasses and alkali-free aluminosilicate glasses, and bubble-free glass ceramics, which do not contain toxic refining-agent components.

It is also an object of the invention to indicate transparent colored, and transparent colorless glasses and glass ceramics that are free of toxic refining-agent components and satisfy the high requirements for quality with respect to absence of bubbles.

Free of toxic refining agents is to be understood in the sense that except for natural impurities of the raw materials used, arsenic and antimony are contained in concentrations of less than 100 ppm in the batch.

Bubble-free and free of bubbles are understood to be a bubble concentration of <2/kg, a bubble denoting a gas inclusion with a diameter>100 μm.

This object is achieved by the features of with respect to the method for producing glasses disclosed herein.

A glass batch that is free of arsenic and antimony is used, wherein at least one sulfate compound and SnO₂ are used as the refining agents, and wherein the average melting temperature T₁ is set at T₁>1560° C., and the average residence time t₁ of the melt is set at t₁>2 hours in a first region of the furnace melting tank. The proportion of SO₃ arising due to the decomposition of the sulfate compound is reduced to less than 0.002 wt. % during the conducting of the primary refining. In a second region, the average melting temperature T₂ is set at T₂>1640° C., and the average residence time t₂ of the melt is set at t₂>1 hour.

Primary refining is understood to be the removal of bubbles (and dissolved gases) in the melting region, i.e., in the region of the first flow vortex up to the source point. In this way, the bubble concentration is already reduced by several orders of magnitude from approximately 10⁷/kg to approximately 10⁴/kg.

Secondary refining is understood to be the process after the first source point (i.e., after the primary refining), wherein, by means of an increase in the temperature of the melt by 50° C. and more, for example, both its viscosity is reduced and simultaneously, the bubble diameter of the bubbles that are present is increased by diffusion of oxygen, so that the bubbles rise more easily and can exit the melt.

The regions for the primary refining and the secondary refining can be separated by fixtures such as blowing nozzles, walls or suspended stones. Also, the primary refining and the secondary refining can be conducted in two separate chambers or two separate furnace melting tanks. Each region is found in a chamber or a tank, the chambers or tanks being joined together, for example, by means of a channel.

Glasses and glass ceramics are preferably understood as those of LAS glasses as well as alkali-free aluminosilicate glasses and glass ceramics produced from these glasses.

LAS glasses are understood to be lithium-aluminosilicate glasses. For producing glass ceramics, these glasses contain nucleating agents, such as, preferably, TiO₂ and ZrO₂. The LAS glasses can be converted into glass ceramics in another thermal process.

In addition to LAS glasses, alkali-free aluminosilicate glasses that contain alkalis in a total concentration of less than 0.2 wt. % can also be produced according to this method.

Average melting temperature is understood to be the time and place-averaged temperature in the region of the respective flow vortex, thus for example, in the first flow vortex.

Average residence time t of the melt in the two regions of a furnace melting tank is understood to be:

$$t = \frac{ρ {A}_{i} {L}_{i}}{\dot{m}}$$

(\dot{m}: mass throughput [kg/d with d=day]; ρ: density of the melt [kg/m³]; Aᵢ: cross-sectional surface of the furnace tank in the i-th section [m²]; Lᵢ: length of the i-th aggregate section [m]).

The average residence time of the melt in the two regions can be adjusted, e.g., by the length of the furnace tank.

Surprisingly, it has been shown in laboratory experiments that a 2-stage refining of LAS glasses with sulfate and SnO₂ makes possible the production of a bubble-free glass, and, in fact, if a very effective primary refining occurs during the melting due to the decomposition of the sulfate into SO₂ and O₂, this is expressed by a great reduction in the concentration of starting bubbles for the secondary refining. In a second step, during the secondary refining (without sulfate), the evolution of O₂ from the SnO₂ is utilized for the refining.

It has been shown that the bubble concentration and the sulfur fraction in the glass melt at the end of the primary refining are of crucial importance for obtaining an end product free of bubbles.

In the primary refining, due to the coupled equilibrium of sulfate and SnO₂, the decomposition of SnO₂ into SnO and O₂ is blocked, so that a higher SnO₂ concentration is provided for the secondary refining than occurs without sulfate addition. The sulfate must be removed practically completely from the melt after the primary refining, so that in the secondary refining, the conversion of the SnO₂ is not blocked, and as much oxygen is evolved as possible, in order to enlarge the bubbles by diffusing in oxygen, and subsequently removing the bubbles.

The decomposition of the SO₃ and that of the SnO₂ takes place according to the following reaction equations:

SO₃→SO₂↑+½O₂

SnO₂ [symbol] SnO+½O₂

It was established that if melting is conducted in the furnace melting tank at temperatures>1560° C. with residence times of >2 h and a primary refining is conducted, a bubble concentration of <5000/kg is already achieved, which is further reduced to <2/kg by the subsequent secondary refining.

It has been shown that with these values at the end of the primary refining, employing a subsequent secondary refining with the decomposition of SnO₂, a glass that is almost completely free of bubbles can be obtained.

The invention is thus based on the knowledge that an almost complete reaction of the sulfate compound must be aimed at, before the secondary refining is conducted. This means that the residual content of SO₃ will amount to less than 0.002 wt. %, preferably <0.0018 wt. %, particularly <0.0015 wt. %

It is thus desirable to break down as much SO₃ as possible into SO₂ and O₂ already preferably in the stage of the raw melting and particularly during the primary refining, so that the released quantity of gas can reinforce the discharging of the gases contained in the glass batch and in the raw melting. The number of starting bubbles is significantly reduced for the subsequent secondary refining.

A preferred temperature range for T₁ is >1560° C. to 1640° C., particularly >1580° C. to 1620° C., and more preferably >1600° C. to 1620° C.

A preferred temperature range for T₂ is >1640° C. to 1720° C., particularly >1660° C. to 1680° C.

The average residence time t₁ preferably lies in the range of >2 h to 25 h, particularly >2 h to 15 h, and more preferably in the range of >2 h to 10 h.

The average residence time t₂ preferably lies in the range of >1 h to 10 h, particularly >1 h to 6 h, and more preferably in the range of >1 h to 4 h.

It is preferred rather to lengthen the average residence time t₁ than the average residence time t₂, since it has been shown that the sulfate decomposition and the gas flow in the first region of the furnace tank are greater than in the second region. For the ratio of t₁/t₂ therefore, 2<t₁/t₂<25 preferably applies, particularly 10<t₁/t₂<25.

Preferably, at least one alkali sulfate and/or at least one alkaline-earth sulfate is added to the glass batch as the sulfate refining agent. Sodium sulfate is preferably employed in the case of alkali sulfates, and BaSO₄ and/or CaSO₄ are/is preferably employed in the case of alkaline-earth sulfates. The higher the temperature is when melting occurs, the alkaline-earth sulfates are more preferred in comparison to alkali sulfates, since the release of SO₂ and O₂ occurs at higher temperatures.

The sulfate compound is preferably added to the glass batch in an amount that corresponds to 0.05 to 1 wt. % SO₃. If the value goes below 0.05 wt. %, then not enough gases are removed in the region of the primary refining, and the bubble concentration is >5000/kg at the end of the primary refining.

If it exceeds a maximum of 1 wt. %, there is the risk of excessive release of gas in the melting and the primary refining, combined with foaming on the glass melt and no longer sufficient removal of bubbles. In addition, the amount of SO₂ increases in the off-gas.

Additional preferred proportions of the sulfate compound are those that correspond to 0.1 to 0.8 wt. %, particularly 0.1 to 0.6 wt. % SO₃.

It has also been shown that the sulfate compound reduces the number of melting remnants. For example, up to 4 wt. % zirconium oxides are melted more rapidly due to the sulfate compound, since the addition of sulfate compound clearly improves the wetting of the zirconium-containing grains and also the sand grains, and suppresses a segregation of the reaction partners during the melting. The dissolution of remnants usually leads to the formation of new small bubbles. If the dissolution of remnants is spread out over the refining region, it is not possible to obtain a bubble-free glass. For this reason, the accelerated dissolution of batch remnants due to the sulfate compound is of great importance for an effective refining.

The raw melting, which describes the transition from the batch to the melt, is characterized by porous batch layers. Depending on the porosity each time, the gases contained in the batch, such as, e.g., N₂, NOₓ and CO₂, can escape more or less easily, and are thus not available in the following processes, or are available only up to a small percentage, for the disruptive bubble formation.

Therefore, a quantity of glass is preferably employed, in which the average grain size of difficult-to-melt components is 10 to 300 μm. Difficult-to-melt components are understood to be the substances: sand (SiO₂), Al₂O₃, and ZrO₂ or zirconium silicates.

The advantage of these grain sizes consists in the fact that the gases contained in the batch can be still better discharged. If the grain size lies in the range of 10 μm to 300 μm, particularly in the range of 50 μm to 250 μm, the discharge of the gases contained in the batch is clearly reinforced.

The duration of the melting in the stage of the raw melting can be adjusted by the selection of the average grain size. The courser the batch is, and, in particular, the larger the average grain size of the difficult-to-melt components is selected, then the residence time t₁ is also selected longer.

SnO₂ is preferably added in an amount of 0.02 to 0.5 wt. %, preferably in an amount of 0.05 to 0.3 wt. %, more preferably from 0.1 to 0.25 wt. %.

Less than 0.02 wt. % SnO₂ does not provide sufficient secondary refining, and the required concentration of bubbles of <2 bubbles/kg is not achievable by far. SnO₂ concentrations of >0.5 wt. % increase the risk for undesired crystallization in the hot-forming process (rolling, floating). In addition, the light transmission Y and the chromaticity C* are adversely affected to beyond a tolerable extent due to the formation of coloring Sn-titanium complexes in the case of transparent, colorless glasses and glass ceramics.

The SnO₂ employed as the refining agent can be utilized advantageously as an O₂ buffer after the secondary refining, in order to suppress the formation of O₂ bubbles on precious metal components.

It is of advantage that with the application of this two-stage refining process with sulfate compound and SnO₂, a high-temperature refining can be completely omitted.

A high-temperature refining is appropriate only for special quality requirements in combination with SnO₂ contents of less than 0.1 wt. %, preferably with SnO₂ contents of 0.02 to <0.1 wt. %. This is then the case if bubble numbers of <1/kg are required, and if particularly high requirements are placed on transmission/brightness and color.

Preferably, the high-temperature refining is conducted in the form of a chemical and physical refining by additional evolution of O₂ refining gas from SnO₂ and by lowering the viscosity of the melt.

The high-temperature refining is conducted preferably at temperatures of >1750° C. to approximately 1950° C. The residence time for the high-temperature refining is at least 12 min., preferably 12 to 20 min., and more preferably at least 15 min.

Preferably, the glass batch is melted in an oxidizing way in the first region. The oxidic melting is produced also by the adjustment of the fossil-fuel burner as well as by the sulfate compound itself and has the advantage that as high a proportion of the sulfate compound as possible is dissolved as SO₃ prior to its decomposition.

Preferably, nitrate is added to the glass batch in an amount of 0 to 3 wt. %. The addition of nitrate as an oxidizing agent, particularly NaNO₃, improves the solubility of sulfur in the melt, which acts in a positive way, as long as the all-too-early decomposition of the sulfate compound produced thereby is inhibited. In addition, the reduction of the O₂ partial pressure in the melt due to any residues of reducing impurities (e.g., organic compounds in the batch) is avoided.

Both transparent colorless and transparent colored glasses can be produced with the method according to the invention.

A glass or a glass ceramic is designated as transparent, if, at a thickness of 4 mm, the transmittance in the wavelength region from 400 nm to 2450 nm amounts to more than 80%.

A glass or a glass ceramic is designated as colorless, if the chromaticity C* in the CIE-LAB color system is <10 for a glass thickness of 4 mm.

A glass or a glass ceramic is designated as colored, if C* 10 for a glass thickness of 4 mm.

The method can be conducted with a continuous or a discontinuous operating mode.

A continuous operating mode is understood to be the melting of glass in the glass melting furnace tank. A continuous operating mode is present if the introduction of raw materials is continuous and almost constant, the raw materials are converted into glass, and the glass is likewise removed in a continuous and almost constant manner at the outlet of the melting aggregate, so that a flow equilibrium with a largely constant volumetric flow is established inside the melting plant.

A discontinuous operating mode is present, if a melting plant is filled with raw materials, these are converted into glass, and at another time point, a pre-specified glass volume is withdrawn, which corresponds at most to the volume of the melting plant; typically, a specific amount of glass is poured into a mold.

Light transmission and color (chromaticity) of the LAS glasses and glass ceramics are influenced in a decisive manner by the quantity of SnO₂ in the glass (see also FIGS. 4 and 5).

It is an advantage that the SnO₂ content can be reduced by addition of sulfate, whereby the light transmission of LAS glasses and glass ceramics is improved and the chromaticity (coloring) is reduced.

The two-stage refining with a sulfate compound and SnO₂ has the great advantage that the quantities of the refining agents, sulfate and SnO₂, can be varied. Small quantities of SnO₂, for example up to <0.1 wt. %, are equilibrated by larger amounts of sulfate compounds. In contrast, SnO₂ quantities of >0.25 wt. % require smaller quantities of sulfate compounds.

The addition of concrete quantities of the two refining agents depends on the required specifications for bubbles and the glass as well as the existing possibilities for the melting aggregate, i.e., how the primary and secondary refinings can be conducted, e.g., with and without fittings.

In addition, the crystallization strength with hot forming and hot post-processing is influenced by the concentration of SnO₂. An SnO₂ reduction is advantageous in order to avoid crystals on shaping tools and in the float process as well as for improving the light transmission and chromaticity.

Another positive effect on the bubble concentration is preferably achieved by other refining additives, such as halides, e.g., chlorides, fluorides, and/or bromides, which are preferably added up to 1 wt. % to the glass batch.

For further simplification of the melting, up to 70 wt. % of shards can be added to the batch, these shards preferably corresponding to the respective glass composition of the batch.

The method for producing glass ceramics provides that a glass is produced according to the method according to the invention and this glass is converted into a glass ceramic by a thermal post-treatment.

The glass or the glass ceramic is characterized in that the glass or the glass ceramic is free of As and Sb, has a bubble concentration of <2/kg, and has a proportion of SO₃ of <0.002 wt. %.

Preferably, the proportion of SO₃ is ≦0.0018 wt. %, in particular ≦0.0015 wt. %.

Preferably, the SnO₂ proportion of the glass or the glass ceramic is 0.02 to 0.5 wt. %, more preferably 0.05 to 0.3 wt. %, and particularly 0.1 to 0.25 wt. %,

This glass or this glass ceramic preferably has the following composition (in wt. %):

| | |
|---|---|
| Li₂O | 2.5-5.5 |
| Na₂O | 0-3.0 |
| K₂O | 0-3.0 |
| Σ Na₂O + K₂O | 0-4.0 |
| MgO | 0-3.0 |
| CaO | 0-5.0 |
| SrO | 0-2.0 |
| BaO | 0-4.0 |
| ZnO | 0.1-4.0 |
| Al₂O₃ | 15-27 |
| SiO₂ | 52-75 |
| TiO₂ | 0-5.5 |
| ZrO₂ | 0.1-4.0 |
| B₂O₃ | 0-4.0 |
| Σ TiO₂ + ZrO₂ | 0.1-6.0 |
| P₂O₅ | 0-8.0 |
| Nd₂O₃ | 0-0.4 |
| SnO₂ | >0.02 |
| TiO₂ + ZrO₂ + SnO₂ | 0.1-6.0 |

Another preferred composition of this glass or this glass ceramic is as follows (in wt. %):

| | |
|---|---|
| Li₂O | 3.0-5.5 |
| Na₂O | 0-1.5 |
| K₂O | 0-1.5 |
| Σ Na₂O + K₂O | 0.2-2.0 |
| MgO | 0-2.0 |
| CaO | 0-4.5 |
| SrO | 0-1.5 |
| BaO | 0-2.5 |
| Σ MgO + CaO + SrO + BaO | 0.5-5.0 |
| ZnO | 0.2-3.0 |
| Al₂O₃ | 17-25 |
| SiO₂ | 55-72 |
| TiO₂ | 0-4.0 |
| ZrO₂ | 0.1-3.0 |
| B₂O₃ | 0-4.0 |
| Σ TiO₂ + ZrO₂ | 0.5-6.0 |
| P₂O₅ | 0-8.0 |
| Nd₂O | 0-0.3 |
| SnO₂ | 0.02-0.5 |
| TiO₂ + ZrO₂ + SnO₂ | 0.5-6.0 |

Preferably, TiO₂ is necessarily contained in the composition of the glass or the glass ceramic. The proportion of TiO₂ is particularly >0.1 wt. %.

The glass according to the invention can be subjected to a hot forming by rolling or preferably in the float method.

Preferably, the transparent, colorless glass ceramic with a layer thickness of 4 mm has a light transmission Y (brightness) of >83% according to the CIE color system and a chromaticity C*<=6 according to the CIE-LAB color system. This applies to impurities in the raw materials and those brought about by the process of Fe₂O₃<=0.024 wt. %.

The spectral light transmission Y is measured on ceramized and polished LAS specimens with a thickness of 4 mm in a Perkin-Elmer Lambda 9000. Subsequently, the conversion to light transmission Y (brightness) is carried out with standard light C according to the ASTM Standard 1925/70.

The chromaticity C* in the CIE-LAB system is defined by C*=\sqrt{A*²+B*²}, wherein A* and B* are the color coordinates in this system. The color coordinates L*, A*, B* in the CIE-LAB system can be converted in the known way into the color coordinates x and y and the light transmission Y (brightness) of the CIE color system.

Preferably, the glass or the glass ceramic can have at least one addition from the group of coloring components V-, Cr-, Mn-, Fe-, Co-, Cu-, Ni-, Ce-, Se-compounds with proportions of up to 1.5 wt. %, whereby transparent, colored glasses and glass ceramics are produced.

Preferred uses of transparent, colored glass ceramics are provided for glass-ceramic cooktops.

Preferred uses of the transparent, colorless glasses or of transparent, colorless glass ceramics are provided for safety glazings in buildings, vehicles, and in the field of personal protection, for viewing windows for displays, for hard-disk substrates, for glass-ceramic cooktops, and for fireplace viewing panels.

### DESCRIPTION OF THE DRAWINGS

The invention will be explained below in more detail on the basis of the figures.

FIG. 1 schematically shows a furnace melting tank with downstream high-temperature aggregate, and

FIG. 2 shows a gas flow/temperature diagram in the case of a refining with the refining agent SnO₂ (comparison measurement), and

FIG. 3 shows a gas flow/temperature diagram in the case of a two-stage refining with the refining agents SO₃ and SnO₂;

FIG. 4 shows the dependence of the light transmission Y on the content of SnO₂ and Nd₂O₃ in the case of transparent, colorless glass ceramics of 4-mm layer thickness and an Fe₂O₃ content of 0.020 wt. %; and

FIG. 5 shows the dependence of the chromaticity C* on the content of SnO₂ and Nd₂O₃ in the case of transparent, colorless glass ceramics of 4-mm layer thickness and an Fe₂O₃ content of 0.020 wt. %.

### DETAILED DESCRIPTION

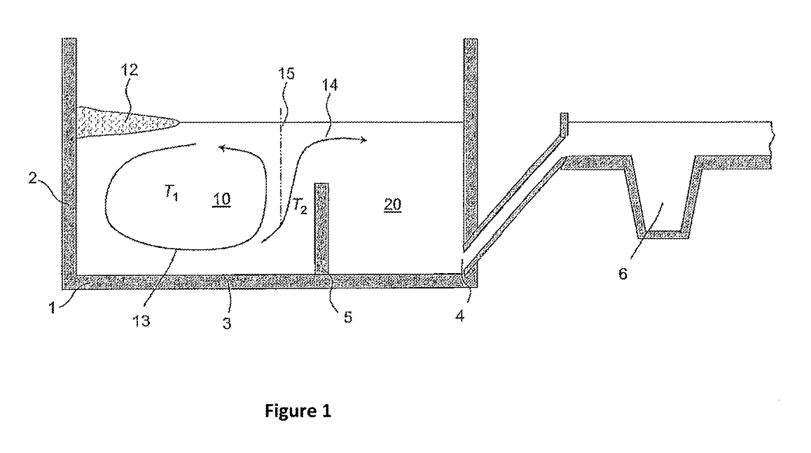

A furnace melting tank 1 with a filling wall 2, a bottom wall 3 and an outlet 4 is shown in FIG. 1. The preferred type of furnace tank is a conventional furnace tank that can be heated by fossil fuel with or without supplemental electrical heating.

The furnace melting tank is divided into a first region 10 and a second region 20. The batch is placed in the first region 10, so that initially a raw melt having a porous batch carpet 12 is formed there. Underneath the batch carpet 12 is found a molten batch, in which non-molten particles, particularly the difficult-to-melt components, are still present in part.

Under the batch carpet 12 is formed a counterclockwise principal flow vortex 13, which sweeps past underneath the batch carpet and continually takes up material and converts it into the melt.

This principal flow vortex 13 extends approximately into the central region of the melting furnace 1, whereby partial flows 14 detach from the principal flow vortex 13, and flow into the second region 20. The regions 10 and 20 can be optionally separated by a built-in component, e.g., a wall 5, by which the hot glass melt is forcibly guided to the surface of the melting furnace.

Two regions are separated by the so-called source point 15, which is also designated the hot spot. This is a region with a high local temperature of the melt.

A primary refining is carried out in the first region 10. The average temperature T₁ in this region 10 lies above 1560° C. In the second region 20, the average temperature T₂ is clearly higher, i.e., over 1640° C. The secondary refining is conducted in this second region.

The average residence time t₁ in the region 10 is more than two hours. The average residence time can be adjusted correspondingly by different parameters, such as, e.g., by the geometric dimensions, particularly the length of the furnace tank.

This is also true for the average residence time t₂ in the second region 20, where the average residence time t₂ shall be at least one hour.

The outlet 4 is optionally connected to a high-temperature aggregate 6, where the high-temperature refining takes place. The high-temperature refining is conducted at temperatures>1750° C. Since the SO₃ proportion is <0.002 wt. %, the undesired reboil effect cannot occur due to this low SO₃ content, so that a bubble-free glass (<2 bubbles/kg, preferably <1 bubble/kg) can be produced at the end of the high-temperature aggregate 6.

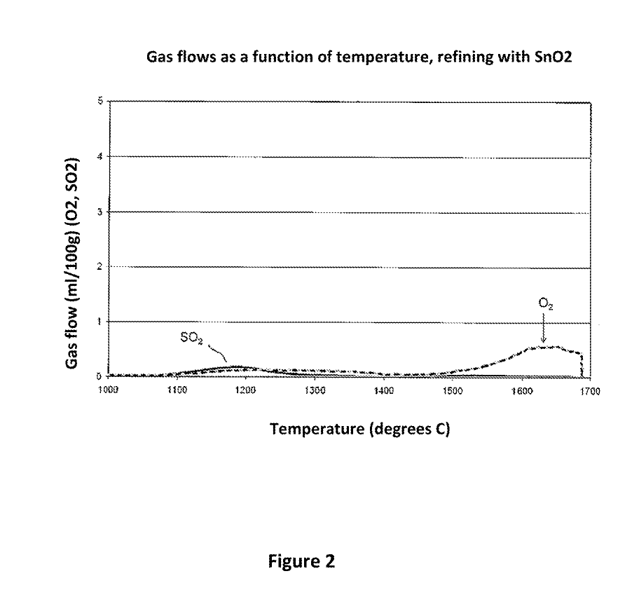

The flow of evolved gas (Evolved Gas Analysis measurements, abbreviated as EGA measurements) of O₂ for the pure SnO₂ refining is plotted in FIG. 2 as a function of temperature for the two regions 10 and 20 of an LAS glass composition. For the measurement, 50 g of batch are heated from room temperature to 1680° C. at 8 K/min, and the evolved gases are analyzed as a function of temperature by means of a mass spectrometer. It is seen that a noteworthy O₂ evolution takes place starting from approximately 1500° C., and reaches the maximum of 0.5 mL/100 g of batch at approximately 1620° C.; this involves a typical gas evolution curve of O₂ from the thermal decomposition of SnO₂ into SnO.

The small evolution of SO₂ and O₂ that can be recognized in FIG. 2 between 1100° C. and 1300° C. can be attributed to unavoidable impurities of sulfate in the raw materials and is not relevant to refining technology.

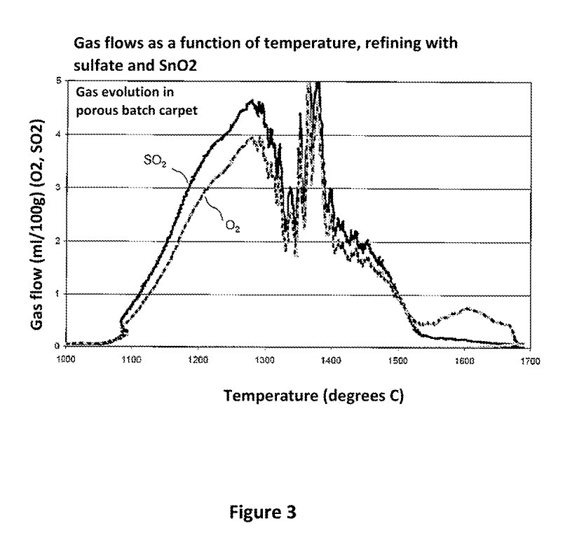

The evolved flow of SO₂ and O₂ gas for the two-stage sulfate-tin refining is plotted in FIG. 3 as a function of temperature for the two regions 10 and 20 of an LAS glass composition. From approximately 1100° C., the evolution of O₂ and SO₂ begins in the porous batch carpet, based on the decomposition of BaSO₄. Gases such as air, for example, which are found between the batch particles, are removed from the batch carpet thereby. With further increasing temperature, the porous batch carpet fuses into a glass melt. After the SO₂ evolution has greatly subsided, from about 1550° C., the secondary refining begins with the evolution of O₂ from the decomposition of SnO₂. Although the same SnO₂ concentration of 0.2 wt. % as in FIG. 2 is present, it can be recognized that in comparison to pure tin refining, the maximum of O₂ increases in the secondary refining region to 0.7 mL/100 g of batch, and, in fact, since the O₂ evolution from the sulfate inhibits the O₂ conversion from the SnO₂ during the primary refining.

The temperatures of the just described gas flows (EGA measurements) cannot be directly converted to furnace tank ratios, since the heating rates and surface-to-volume ratios differ between the laboratory measurements and the furnace tank; the measurements indicate the temperature regions of the evolution of refining gas under laboratory conditions. The actual temperatures of the gas evolution were determined in the small furnace tank test and are shifted to higher temperatures in comparison to the EGA measurements.

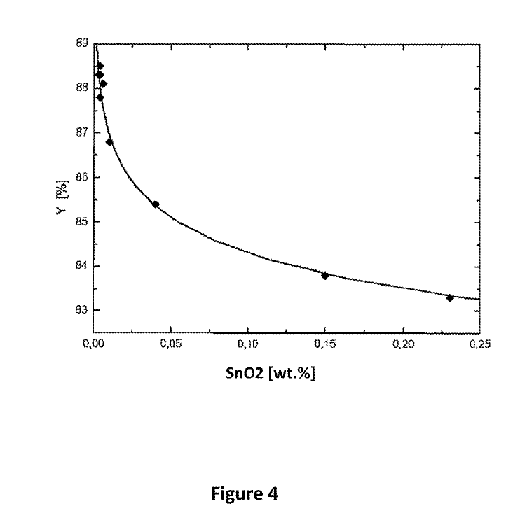

FIG. 4 shows the dependence of the light transmission Y on the SnO₂ and Nd₂O₃ contents of transparent, colorless glass ceramics with 4-mm layer thickness.

Composition 1 from Table 1 was melted in a small furnace tank with different SnO₂ contents. The analyzed SnO₂ values lie between 0.23 wt. % and 0.003 wt. %, and the analyzed Fe₂O₃ contents each amount to 0.020 wt. %. With decreasing SnO₂ content from 0.23 wt. % to 0.003 wt. %, the Nd₂O₃ content also decreased from 0.048 wt. % to <0.005 wt. %.

The graph in FIG. 4 shows a very great dependence of the light transmission Y on the SnO₂ and Nd₂O₃ contents. The higher the SnO₂ and Nd₂O₃ contents are in each case, the poorer is the light transmission Y. The light transmission Y lies between 83.3% in the case of 0.23 wt. % SnO₂ and 0.048 wt. % Nd₂O₃ and 88.2% in the case of 0.02 wt. % SnO₂ and <0.005 wt. % Nd₂O₃. The drawn-in curve is the logarithmic regression curve of the measurement points.

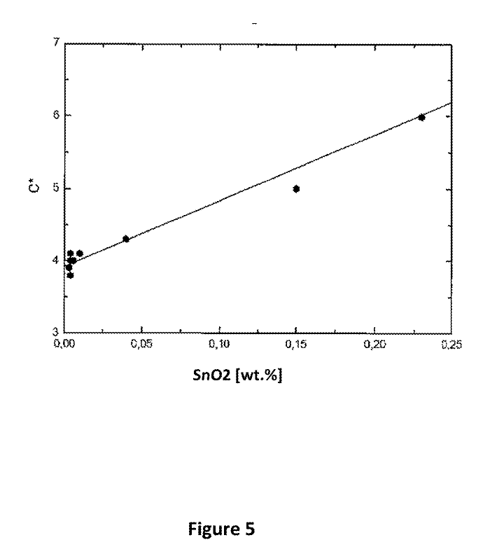

FIG. 5 shows the dependence of the chromaticity C* on the SnO₂ and Nd₂O₃ contents of transparent, colorless glass ceramics with 4-mm layer thickness. Composition 1 from Table 1 was melted in a small furnace tank with different SnO₂ contents. The analyzed SnO₂ values lie between 0.23 wt. % and 0.003 wt. %, and the analyzed Fe₂O₃ contents each amount to 0.020 wt. %. The higher the SnO₂ content is in each case, the poorer the chromaticity C* is. The chromaticity C* can be improved with the addition of Nd₂O₃. Therefore, 0.048 wt. % Nd₂O₃ was added in the case of 0.23 wt. % SnO₂. With decreasing SnO₂ content from 0.23 wt. % to 0.003 wt. %, the Nd₂O₃ content also decreased from 0.048 wt. % to <0.005 wt. %. The graph shows a very great dependence of the chromaticity C* on the SnO₂ and Nd₂O₃ contents. The chromaticity C* lies between 6 in the case of 0.23 wt. % SnO₂ and 0.048 wt. % Nd₂O₃ and 3.9 in the case of 0.02 wt. % SnO₂ and <0.005 wt. % Nd₂O₃. The drawn-in line is the regression line for the measurement points

The invention will be explained in more detail on the basis of examples:

TABLE 1
Glass compositions from the following Examples

| | | | | | | Composition 6 | Composition 7 |
|---|---|---|---|---|---|---|---|
| | | | | | | (Comparative | (Comparative |
| In wt. % | Composition 1 | Composition 2 | Composition 3 | Composition 4 | Composition 5 | example 2) | example 1) |
| SiO₂ | 66.9 | 66.9 | 65.0 | 65.1 | 65.2 | 65.2 | 66.9 |
| Al₂O₃ | 21.2 | 21.3 | 22.2 | 20.9 | 20.8 | 20.8 | 21.2 |
| Fe₂O₃ | 0.02 | 0.02 | 0.019 | 0.085 | 0.12 | 0.087 | 0.02 |
| Na₂O | 0.4 | 0.4 | 0.6 | 0.6 | 0.6 | 0.5 | 0.4 |
| K₂O | 0.07 | 0.07 | — | 0.22 | 0.24 | 0.16 | 0.07 |
| CaO | 0.12 | 0.12 | — | 0.42 | 0.44 | 0.42 | 0.12 |
| MgO | 0.83 | 0.83 | 0.59 | 0.37 | 0.34 | 0.34 | 0.83 |
| SrO | 0.48 | 0.48 | | 0.02 | 0.10 | 0.02 | 0.48 |
| BaO | 0.73 | 0.73 | 2.02 | 2.3 | 2.19 | 2.22 | 0.73 |
| TiO₂ | 2.13 | 2.13 | 2.26 | 3.1 | 3.11 | 3.11 | 2.36 |
| ZnO | 1.60 | 1.60 | 1.76 | 1.5 | 1.52 | 1.52 | 1.6 |
| ZrO₂ | 1.70 | 1.70 | 1.76 | 1.34 | 1.38 | 1.41 | 1.7 |
| Li₂O | 3.54 | 3.54 | 3.8 | 3.71 | 3.61 | 3.95 | 3.54 |
| Nd₂O₃ | 0.048 | 0.028 | — | — | 0.015 | — | — |
| SnO₂ | 0.25 | 0.15 | 0.10 | 0.24 | 0.24 | 0.22 | — |
| SO₃ | 0.26 | 0.26 | 0.53 | 0.26 | 0.53 | — | 0.26 |
| synthesis | | | | | | | |
| MnO₂ | — | — | — | 0.01 | 0.02 | 0.01 | — |
| V₂O₅ | — | — | — | 0.026 | 0.024 | 0.023 | — |

SO₃ synthesis means: Quantity of SO₃ in wt. %; the quantity of BaSO₄ that is added to the batch is calculated from the quantity of SO₃. All other data are analytically determined values in the glass.

### Example I (Small Furnace Tank)

An Nd₂O₃-containing LAS glass composition (composition 1) containing 0.25 wt. % SnO₂ was melted in a small furnace tank. The batch contained 0.26 wt. % SO₃, added as Ba sulfate. Commercial technical raw materials were used (quartz powder, Al₂O₃, Al hydroxide, Na nitrate, K carbonate, Li carbonate, MgO, TiO₂, zirconium silicate, ZnO, Ca carbonate, Sr carbonate, Ba carbonate, Nd₂O₃, SnO₂, Ba sulfate) with a total content of Fe₂O₃ of 0.02 wt. %. No coloring oxides were added to the batch. 0.4 wt. % Na₂O was added as Na nitrate. After average melting temperatures of approximately 1580° C. to 1600° C. for the primary refining, the average melting temperature for the secondary refining was increased to 1640° C. The average residence times were >4 h in each case. Samplings after the furnace tank showed that the glass was melted free of remnants. The bubble concentration lay between 10 and 100 bubbles/kg each time, depending on melting parameters (melting temperature and residence time). The content of SO₃ at the end of the furnace tank in each case was less than 0.0012 wt. %; the analyzed concentration of SnO₂ in the glass was 0.23 wt. %. Approximately 40% to 50% of the SnO₂ was converted to SnO.

The subsequent high-temperature refining at temperatures between 1760° C. and max. 1850° C. with average residence times of 15 min led to transparent, colorless glass with bubble concentrations stable at <1 bubble/kg. The thus-produced, colorless Nd₂O₃-containing LAS glass was converted into a glass ceramic by ceramicizing and its transmission and color were measured. The glass ceramic with a layer thickness of 4 mm had a light transmission Y according to the CIE color system of 83.5% and a chromaticity C* in the CIE-LAB color system of 6.0.

### Example 2 (Small Furnace Tank without High-Temperature Refining)

As in Example 1, the Nd₂O₃-containing LAS glass composition 1 was melted with 0.25 wt. % SnO₂ and 0.26 wt. % SO₃, added as Ba sulfate in a small furnace tank with comparable raw materials. The batch did not have any addition of coloring oxides. After average melting temperatures of approximately 1600° C. and average residence times of >5 h for the primary refining, the average melting temperature for the secondary refining was increased to approximately 1660° C. The average residence times were more than 3 h. The glass was melted free of remnants. The SO₃ content after the furnace tank was less than 0.0012 wt. % and the bubble concentration (bubbles>100 μm) decreased in a stable manner to less than 2 bubbles/kg. A high-temperature refining was no longer necessary.

### Example 3 (Laboratory Test with a Small Amount of SnO₂)

In the gas furnace, a 1.4-kg batch of LAS composition 3 containing conventional technical raw materials was melted with 0.10 wt. % SnO₂ and 0.53 wt. % SO₃ as BaSO₄ for 4 h at 1600° C. It was subsequently stirred and the temperature was raised to 1680° C. and kept for another 4 h at 1680° C. After pouring, the glass contained approximately 50 bubbles/kg; the SO₃ content was 0.0010 wt. %. After evaluating the glass in the cold state, the glass was subjected to a high-temperature refining. For this purpose, cylindrical cores were prepared from the just described glass suitable for the crucible of the high-temperature refining. A 55-mm high core was heated again to 1600° C. in an Ir crucible having a volume of 140 mL, kept at 1600° C. for 30 min. for uniform thorough melting, and then heated at 975 K/h to 1925° C. and kept for 12 min at the high temperature. Subsequently, the hot glass was cooled to 1500° C. in approximately 8 min, kept for 10 min, and then thermally annealed to room temperature in the cooling furnace.

The glass was completely free of bubbles; all bubbles were removed, and there was no new bubble formation in the high-temperature refining aggregate.

The glass was converted into a glass ceramic by thermal treatment. The glass ceramic with a layer thickness of 4 mm had a transmission Y according to the CIE color system of 86.2% and a chromaticity C* in the CIE-LAB color system of 4.3.

### Example 4 (Small Furnace Tank with a Small Amount of SnO₂)

The transmission and, in particular, the color of the LAS glass ceramics are strongly dependent on the SnO₂ content.

SnO₂ contents of 0.15 wt. %, in addition to 0.26 wt. % SO₃ in the batch (composition 2), after the furnace tank operation described according to Example 1, as well as after the ceramicizing lead to a light transmission Y according to the CIE color system of 83.8% at 4 mm layer thickness and to a chromaticity C* in the CIE-LAB color system of 5.0 at 4 mm layer thickness. The number of bubbles obtained was <2/kg.

Further decreasing SnO₂ content further improves the light transmission and color. With a decrease in the SnO₂ content, the Nd₂O₃ content was also reduced. SnO₂ contents of 0.02 wt. %, in addition to 0.26 wt. % SO₃, in the batch (basic composition 2, of course, without Nd₂O₃ addition), after the furnace tank operation described according to Example 1, as well as after the ceramicizing lead to a light transmission Y according to the CIE color system of 88.2% and to a chromaticity C* in the CIE-LAB color system of 3.9 at 4 mm layer thickness. For a sufficient refining, the decrease of the SnO₂ content had to be compensated by higher melting temperatures both for the primary as well as the secondary refining. With SnO₂ contents of <0.1 wt. %, the average melting temperature T₁ was approximately 1630° C. and T₂ was 1680° C., combined with average residence times of >4 h.

### Comparative Example 1 (Refining Agent Only SO₃)

Without simultaneous SnO₂ addition, thus with pure sulfate refining, the secondary refining step in the furnace is omitted, and a high-temperature refining is absolutely necessary.

An Nd₂O₃-free LAS glass composition 7 was melted in a furnace tank without SnO₂ addition. Commercial technical raw materials were used (quartz powder, Al₂O₃, Al hydroxide, Na nitrate, K carbonate, Li carbonate, MgO, TiO₂, zirconium silicate, ZnO, Ca carbonate, Sr carbonate, Ba carbonate, Ba sulfate) with a total Fe₂O₃ content of 0.02 wt. %. The batch contained 0.26 wt. % SO₃, added as Ba sulfate. No coloring oxides were added to the batch. 0.4 wt. % Na₂O was added as Na nitrate. After melting temperatures of 1620° C. for the primary refining, the average melting temperature for the secondary refining was increased to over 1650° C. The glass was melted free of remnants. The bubble concentration at the end of the furnace tank could not be reduced to sufficiently small values of <2 bubbles/kg; it was approximately 50 bubbles/kg, in part up to 500 bubbles/kg, each time depending on the selected melting parameters (melting temperature and residence time).

### Example 5 (Laboratory Colored Glass Ceramics)

In the laboratory, a 1.4-kg batch of LAS glass composition 5 containing conventional raw materials (quartz powder, Al₂O₃, Al hydroxide, K carbonate, Ca carbonate, Sr carbonate and Ba carbonate, Na nitrate, Li carbonate, petalite/spodumene, MgO, TiO₂, zirconium silicate, ZnO, Nd₂O₃, SnO₂, Ba sulfate) and 0.53 wt % SO₃ refining agent as Ba sulfate was prepared.

The batch was melted without remnants in the gas furnace at temperatures of 1580° C. for 4 h and subsequently stirred in a 50-Hz heated coil in the silica glass crucible and kept for 3 h at 1640° C., in order to carry out a secondary refining. After the end of the melting time, the glass was poured and cooled at 20 K/h. Glass prepared in this way still contained approximately 300 bubbles/kg of glass. The analyzed SO₃ content was 0.0015 wt. %. After the evaluation of the glass in the cold state, the glass was subjected to a high-temperature refining at 1860° C. with a residence time of 12 min, the procedure being comparable to Example 3. The glass was completely free of bubbles; all bubbles were removed, and there was no new bubble formation in the high-temperature refining aggregate.

### Example 6 (Small Furnace Tank, Colored Glass Ceramics)

An Nd-free LAS glass composition 4 was melted with 0.24 wt. % SnO₂ in a furnace tank. Commercial technical raw materials were used (quartz powder, Al₂O₃, Al hydroxide, K carbonate, Ca carbonate, and Ba carbonate, Na nitrate, Li carbonate, petalite/spodumene, MgO, TiO₂, zirconium silicate, ZnO, SnO₂, Ba sulfate). The batch contained 0.26 wt. % SO₃, added as Ba sulfate. Approximately 0.026 wt. % V₂O₅ and 0.09 wt. % Fe₂O₃ as coloring oxides were added to the batch. 0.59 wt. % Na₂O was added as Na nitrate. After average melting temperatures of approximately 1580° C. for the primary refining, the average temperature for the secondary refining was increased to 1640° C. The average residence times for the secondary refining were between 3 and 8 h. Samplings after the furnace tank showed that the glass was melted free of remnants. The bubble concentrations were approximately 20 bubbles/kg, each time depending on the melting parameters (melting temperature and residence time), and even up to 300 bubbles/kg. The SO₃ content was between 0.0010 and 0.0013 wt. %. The subsequent high-temperature refining at temperatures between 1760° C. and approx. 1850° C. with average residence times of 15 min led to glass with a bubble concentration of <1 bubble/kg.

When the melting temperatures for primary and secondary refining were raised in each case by approximately 40 K, after the furnace tank, bubble concentrations of <2 bubbles/kg were stably obtained. A high-temperature refining was not necessary.

### Comparative Example 2 (Refining Agent Only SnO₂)

If the LAS composition 6 is melted in the furnace tank under comparable melting conditions as in Example 1, of course, without addition of sulfate (pure SnO₂ refining), it was not possible, even with high-temperature refining, to arrive stably at bubble concentrations of less than 2 bubbles/kg. The glass was not melted free of remnants; ZrO₂-containing melting remnants always appeared again in the product, and these residual remnants are permanent sources of bubbles. This is particularly disadvantageous, if, after completing the refining in the furnace tank or in the course of high-temperature refining, new relatively small bubbles are continually formed due to the dissolution of the remnants.

Higher melting temperatures may in fact reduce the melting remnants, but too much SnO₂ is already converted to SnO in the raw melting. In the secondary refining, sufficient O₂ from the SnO₂ conversion is then no longer available for the growth of bubbles, and the bubbles cannot be completely removed.

Based on these Examples, it can be clearly seen that with a combined sulfate and SnO₂ refining, in the case of colorless and colored LAS glass compositions, while maintaining the claimed parameters, a bubble-free glass can be produced with and without high-temperature refining. The bubble concentrations of the comparative tests show that with SnO₂ alone or sulfate alone, without the use of high-temperature refining, a bubble quality of <2 bubbles/kg cannot be stably obtained.

### LIST OF REFERENCE NUMBERS

1 Furnace melting tank
2 Filling wall
3 Bottom wall
4 Outlet
5 Wall
6 High-temperature crucible
10 First region
12 Batch carpet
13 Principal flow vortex
14 Partial flow
15 Source point
20 Second region

What is claimed is:

1. A method for producing glasses, comprising:
using a glass batch that is free of arsenic and antimony except for unavoidable raw-material impurities;
using at least one sulfate compound and SnO₂ as refining agents;
melting and primarily refining the glass batch containing the refining agent in a first region of a furnace melting tank, wherein in the first region, an average melting temperature T₁ is set at T₁>1560° C. and an average residence time t₁ is set at t₁>2 hours, and proportion of SO₃ arising due to decomposition of the at least one sulfate compound is reduced to less than 0.002 wt. % during the primary refining; and
secondarily refining in a second region of the melting furnace tank, wherein in the second region, an average melting temperature T₂ is set at T₂>1640° C. and an average residence time t₂ is set at t₂>1 hour.

2. The method according to claim 1, further comprising adding at least one alkali sulfate and/or at least one alkaline-earth sulfate to the glass batch as the refining agents.

3. The method according to claim 1, further comprising adding BaSO₄ and/or CaSO₄ to the glass batch as the refining agents.

4. The method according to claim 1, further comprising adding Na₂SO₄ to the glass batch as the refining agents.

5. The method according to claim 1, wherein the at least one sulfate compound is added to the glass batch in an amount that corresponds to 0.05 to 1 wt. % of SO₃.

6. The method according to claim 1, wherein the SnO₂ is added in an amount of 0.02 to 0.5 wt. %.

7. The method according to claim 1, further comprising performing a third refining step as a high-temperature refining at temperatures>1750° C.

8. The method according to claim 7, wherein the high-temperature refining is conducted over a time period of at least 12 min.

9. The method according to claim 1, wherein, in the first region, the melting is conducted in an oxidizing manner.

10. The method according to claim 1, further comprising adding nitrate to the glass batch in a concentration of 0 to 3 wt. %.

11. The method according to claim 1, wherein the glasses produced are transparent, colorless glasses.

12. The method according to claim 1, further comprising adding coloring components so that the glasses produced are transparent, colored glasses.

13. The method according to claim 1, further comprising exposing the glass batch to a thermal treatment sufficient to convert the glass batch into a glass ceramic.

14. The method according to claim 13, wherein the glass ceramic is transparent, colored glass ceramic suitable for a use selected from the group consisting of a cooktop, a safety glazing in a building, a safety glazing in a vehicle, a personal protection device, a viewing windows for a display, a hard-disk substrate, and a fireplace viewing panel.

15. A glass or glass ceramic that is free of As and Sb except for unavoidable raw-material impurities, has a bubble concentration of <2/kg, and has a proportion of SO₃ of <0.002 wt. %.

16. The glass or glass ceramic according to claim 15, comprising a composition (in wt. %):

| | |
|---|---|
| Li₂O | 2.5-5.5, |
| Na₂O | 0-3.0, |
| K₂O | 0-3.0, |
| Σ Na₂O + K₂O | 0-4.0, |
| MgO | 0-3.0, |
| CaO | 0-5.0, |
| SrO | 0-2.0, |
| BaO | 0-4.0, |
| ZnO | 0.1-4.0, |
| Al₂O₃ | 15-27, |
| SiO₂ | 52-75, |
| TiO₂ | 0-5.5, |
| ZrO₂ | 0.1-4.0, |
| B₂O₃ | 0-4.0, |
| Σ TiO₂ + ZrO₂ | 0.1-6.0, |
| P₂O₅ | 0-8.0, |
| Nd₂O₃ | 0-0.4, |
| SnO₂ | >0.02, and |
| TiO₂ + ZrO₂ + SnO₂ | 0.1-6.0. |

17. The glass or glass ceramic according to claim 15, comprising a composition (in wt. %):

| | |
|---|---|
| Li₂O | 3.0-5.5, |
| Na₂O | 0-1.5, |
| K₂O | 0-1.5, |
| Σ Na₂O + K₂O | 0.2-2.0, |
| MgO | 0-2.0, |
| CaO | 0-4.5, |
| SrO | 0-1.5, |
| BaO | 0-2.5, |
| Σ MgO + CaO + SrO + BaO | 0.5-5.0, |
| ZnO | 0.2-3.0, |
| Al₂O₃ | 17-25, |
| SiO₂ | 55-72, |
| TiO₂ | 0-4.0, |
| ZrO₂ | 0.1-3.0, |
| B₂O₃ | 0-4.0, |
| Σ TiO₂ + ZrO₂ | 0.5-6.0, |
| P₂O₅ | 0-8.0, |
| Nd₂O₃ | 0-0.3, |
| SnO₂ | 0.02-0.5, and |
| TiO₂ + ZrO₂ + SnO₂ | 0.5-6.0. |

18. The glass or glass ceramic according to claim 15, wherein the glass or glass ceramic is transparent, colorless glass ceramic with a layer thickness of 4 mm, has a light transmission Y>83% according to the CIE color system, and has a chromaticity C*<=6 in the CIE-LAB color system.

19. The glass or glass ceramic according to claim 15, wherein the glass or glass ceramic is transparent, colored glass or transparent, colored glass ceramic with at least one addition from the group of coloring components selected from the group consisting of V—, Cr—, Mn—, Fe—, Co—, Cu—, Ni—, Ce—, and Se— compounds with proportions of up to 1.5 wt. %,

20. The glass or glass ceramic according to claim 15, wherein the glass or glass ceramic is transparent, colored glass ceramic suitable for a use selected from the group consisting of a cooktop, a safety glazing in a building, a safety glazing in a vehicle, a personal protection device, a viewing windows for a display, a hard-disk substrate, and a fireplace viewing panel.
